(19) United States
(12) Patent Application Publication
(10) Pub. No.: US 2006/0255153 A1
(43) Pub. Date: Nov. 16, 2006

(54) Handheld fingerprint-capturing device

(75) Inventors: Chia-Chu Cheng, Hsin-Tien City (TW); Ming-Ho Wang, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/411,903

(22) Filed: Apr. 27, 2006

(30) Foreign Application Priority Data
May 13, 2005 (TW) 94115710

(51) Int. Cl. G06K 7/10

(52) U.S. Cl. 235/472.01

(57) ABSTRACT

A handheld fingerprint-capturing device includes a built-in camera module for capturing an image, an image reception module having a data transmission interface, which is electrically connected to the camera module and provided with a protocol for communicating with the camera module, and a fingerprint-capturing module that is compatible with the data transmission interface for transmitting a fingerprint to the image reception module via the data transmission interface. Thus, the fingerprint-capturing module can easily integrate with the camera module in the handheld device via the data transmission interface, so that the devices can be easily integrated with each other.

### BACKGROUND OF THE INVENTION

1. Field of The Invention

The present invention relates to a handheld fingerprint-capturing device, and particularly relates a handheld fingerprint-capturing device that has a built-in camera module and a built-in image reception module for transmitting information about fingerprint.

2. Description of the Related Art

With the advancement and rapid change of semi-conductive technology, handheld devices are becoming more common, while their applications are becoming more and more diverse. Furthermore, both computers and the Internet are becoming more wide-spread and popular. As such, we can see a tendency towards the development of a digital personal recognition system, which is integrated with computers, the Internet, mobile phones, entrance controls, means of transportation, electrical business, credit cards, cash cards as well as an individuals medical records.

Fingerprint identification is an important part of a digital personal recognition system. A large quantity of person identification can be processed shortly after a comparison with other fingerprints via algorithms. Reference is made to FIG. 1, which is a diagram of a conventional middle to high-end phone or smart phone with a built-in camera module and a fingerprint-capturing module. The conventional phone includes a built-in compact camera module la, an image reception module 2a, a baseband CPU 3a, a fingerprint-capturing module 4a, a memory bus 5a or a serial peripheral interface bus (SPI in short) 6a, and a memory storage module 7a.

The compact camera module 1a catches at least one image. The image reception module 2a includes a data transmission interface 20a. The image reception module 2a is provided with protocol for receiving the image. The data transmission interface 20a has a control pin set 21a communicating with and sending instructions to the camera module la and an image pin set 22a receiving the image from the camera module la. Therefore, the image can be transmitted to the image reception module 2a via the data transmission interface 20a. The baseband CPU 3a electrically connects with the image reception module 2a and the memory storage module 7a, so as to further process the image.

The fingerprint-capturing module 4a electrically connects the baseband CPU 3a via the memory bus 5a (in parallel connection) or the SPI 6a (in serial connection), so as to further process the image.

Reference is made to FIG. 2, which is a diagram of a conventional PDA or PDA phone with a built-in camera module and a fingerprint-capturing module. The distinguishing feature of the PDA shown in FIG. 2 is a system CPU 8a replaces the baseband CPU 3a.

The fingerprint-capturing module 4a connects to the system CPU 8a via the memory bus 5a or the SPI 6a for transmitting the image. However, making a special effort to design the memory bus 5a particularly for the memory storage module 7a is troublesome, because the common standard between the memory bus 5a and the memory storage module 7a isn't set up yet. Furthermore, the transmission speed of the SPI is very slow. Moreover, the protocol is not commonly applicable between the fingerprint-capturing module 4a and the baseband CPU 3a, or the fingerprint-capturing module 4a and the system CPU 8a. These shortages will hinder integrating a system, raise it's complexity, and make it more difficult to use.

### SUMMARY OF THE INVENTION

A handheld fingerprint-capturing device according to the present invention is provided with a fingerprint-capturing module designed with a transmission interface similar to the one that communicates between a camera module and an image reception module. The similar interfaces of the two devices makes the fingerprint-capturing module easily integrated with the handheld device, so that the previously mentioned integration complexity between the fingerprint-capturing module and a CPU is avoided.

A handheld fingerprint-capturing device according to the present invention includes a built-in camera module, an image reception module, and a fingerprint-capturing module. The built-in camera module catches at least one image. The image reception module includes a data transmission interface, which is provided with protocol for receiving the image. The data transmission interface has a control pin set communicating with and commanding the camera module, and an image pin set receiving the image from the camera module. The fingerprint-capturing module is compatible with the protocol of the data transmission interface and captures at least one fingerprint. The fingerprint-capturing module electrically connects with the image reception module, and the fingerprint is transmitted to the image reception module via the data transmission interface

In addition, the handheld fingerprint-capturing device further includes a processing module electrically connected with the image reception module; and a memory storage module electrically connected with the processing module for saving the image or the fingerprint received from the image reception module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a diagram of a conventional middle to high-end phone or smart phone with a built-in camera module and a fingerprint-capturing module;

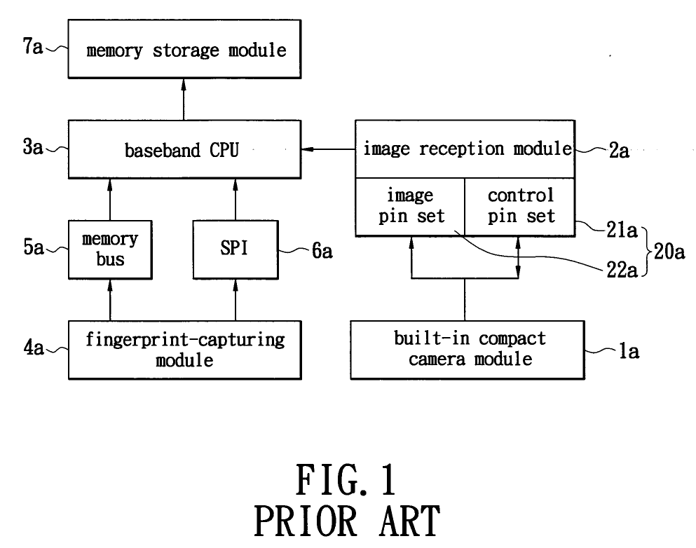

FIG. 2 is a diagram of a conventional PDA or PDA phone with a built-in camera module and a fingerprint-capturing module; and

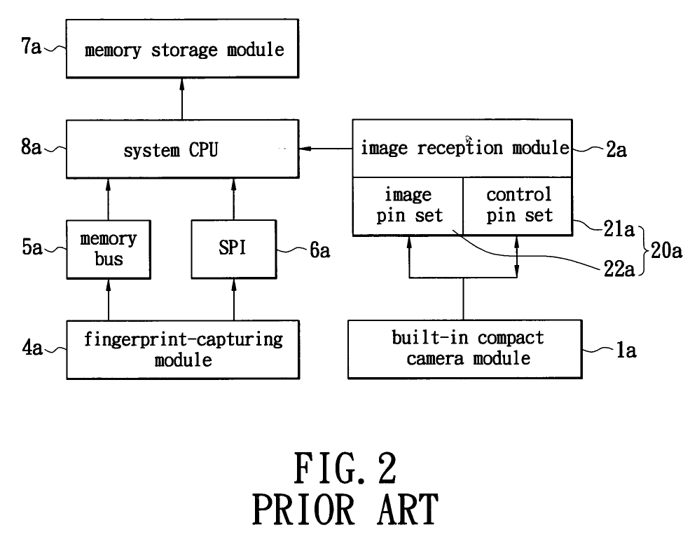

FIG. 3 is a diagram of a handheld fingerprint-capturing device according to the present invention.

### DETAILED DESCRIPTION OF PREFERRED EMBODIMENTS

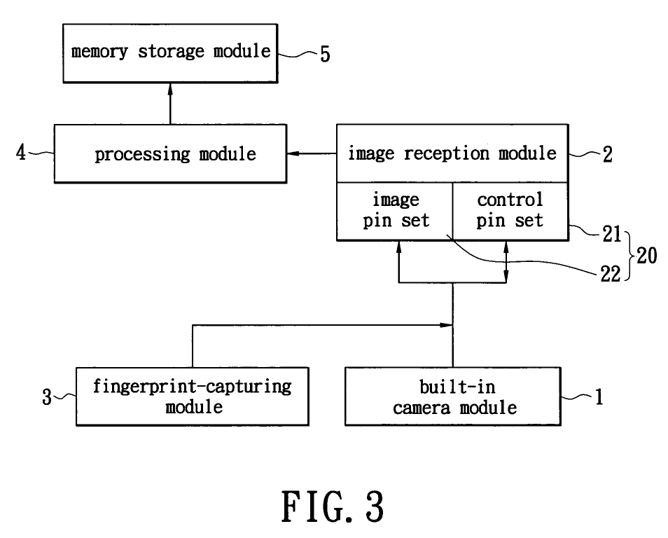

Reference is made to FIG. 3, which is a diagram of a handheld fingerprint-capturing device according to the present invention. The handheld fingerprint-capturing device includes a built-in camera module 1 capturing at least one image, an image reception module 2 and a fingerprint-capturing module 3. The handheld device can be a mobile phone, a Personal Digital Assistant (PDA), or a similar handheld or portable device.

The camera module 1 can be a Compact Camera Module (CCM) or a similar device that can take pictures. The image reception module 2 has a data transmission interface 20, which is provided with at least one protocol for receiving the image from the camera module 1. The protocol of the image reception module 2 has at least one identification code for recognizing the built-in camera module 1 and the fingerprint-capturing module 3.

In addition, the data transmission interface 20 has a control pin set 21 communicating with and commanding the camera module 1, and an image pin set 22 receiving the image from the camera module 1. The control pin set 21 has a working clock, a horizontal synchronization signal, a vertical synchronization signal, and at least two command lines for communicating with or/and commanding the camera module 1 or the fingerprint-capturing module 3 in a sequential manner. That means the image reception module 2 transmits instructions to the built-in camera module 1 to confirm the identification code thereof via the control pin set 21 of the data transmission interface 20 first. After the confirmation step, the built-in camera module 1 catches at least one image. The built-in camera module 1 informs the image reception module 2 via the control pin set 21 in order to receive the captured image via the image pin set 22. Alternatively, after the confirmation step, the image reception module 2 informs the camera module 1 via the control pin set 21, and the camera module 1 transmits the captured image to the image reception module 2 via the image pin set 22 for further processing.

Furthermore, the fingerprint-capturing module 3 is used to capture at least one fingerprint. The fingerprint-capturing module 3 includes an identification code for recognition by the handheld device. The fingerprint-capturing module is an area-type module or a linear-type module. The fingerprint-capturing module 3 includes at least one Register Table that is addressed in advance and is capable of being revised and modified. As such, the image reception module 2 can communicate with or/and transmit instructions to the fingerprint-capturing module 3 via the Register Table.

In addition, the fingerprint-capturing module 3 electrically connects with the image reception module 2 and is compatible with the protocol of the data transmission interface 20. As such, at least one fingerprint can be transmitted into the image reception module 2 via the data transmission interface 20. In other words, the fingerprint-capturing module 3 can utilize the existing data transmission interface 20 and the protocol thereof to transmit the fingerprint to the image reception module 2. No further interface and protocol between the fingerprint-capturing module 3 and the image reception module 2, apart from the identification codes from each side, is required.

The handheld device further includes a processing module 4 and a memory storage module 5. The processing module 4 electrically connects with the image reception module 2. The memory storage module 5 electrically connects with the processing module 4 for saving the image or the fingerprint from the image reception module 2. Moreover, the processing module 4 is a Backend IC, a Digital Signal Processor (DSP) or a baseband CPU. The memory storage module 4 can be built internally in the image reception module 2 or be externally connected to the image reception module 2.

The handheld fingerprint-capturing device according to the present invention is provided to design the data transmission interface of the fingerprint-capturing module 3 so that the interface is similar to the one that exists between the camera module 1 and the reception module 2. Therefore, the fingerprint-capturing module 3 can be easily integrated with the built-in camera module 1 as a part of the handheld device, so as to reduce the complexity of the integration of the fingerprint-capturing module 3 with the handheld device.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A handheld fingerprint-capturing device comprising:
a built-in camera module capturing at least one image;
an image reception module including a data transmission interface, which is provided with a protocol for receiving the image; wherein the data transmission interface has a control pin set communicating with and transmitting instructions to the camera module, and an image pin set receiving the image from the camera module; and
a fingerprint-capturing module that is compatible with the protocol of the data transmission interface and capturing at least one fingerprint, wherein the fingerprint-capturing module electrically connects with the image reception module, and the fingerprint is transmitted to the image reception module via the data transmission interface.

2. The handheld fingerprint-capturing device as claimed in claim 1, wherein the protocol of the image reception module has at least one identification code for recognizing the built-in camera module and the fingerprint-capturing module.

3. The handheld fingerprint-capturing device as claimed in claim 1, wherein the fingerprint-capturing module includes at least one Register Table that is addressed in advance and is capable of being revised and modified, so that the image reception module communicates with and transmits instructions to the fingerprint-capturing module via the Register Table.

4. The handheld fingerprint-capturing device as claimed in claim 1, wherein the data transmission interface of the image reception module has a working clock, a horizontal synchronization signal and a vertical synchronization signal.

5. The handheld fingerprint-capturing device as claimed in claim 1, wherein the control pin set includes at least two command lines for communicating with or/and commanding the camera module or the fingerprint-capturing module in a sequential manner.

6. The handheld fingerprint-capturing device as claimed in claim 1, wherein the fingerprint-capturing module includes an identification code for recognition.

7. The handheld fingerprint-capturing device as claimed in claim 1, wherein the fingerprint-capturing module is an area-type module.

8. The handheld fingerprint-capturing device as claimed in claim 1, wherein the fingerprint-capturing module is a linear-type module.

9. The handheld fingerprint-capturing device as claimed in claim 1, wherein the handheld device is a mobile phone or a Personal Digital Assistant (PDA).

10. The handheld fingerprint-capturing device as claimed in claim 1, wherein the camera module is a Compact Camera Module (CCM).

11. The handheld fingerprint-capturing device as claimed in claim 1, further including:
a processing module electrically connected with the image reception module; and
a memory storage module electrically connected with the processing module for saving the image or the fingerprint received from the image reception module.

12. The handheld fingerprint-capturing device as claimed in claim 11, wherein the memory storage module is built internally in the image reception module or externally connected to the image reception module.

13. The handheld fingerprint-capturing device as claimed in claim 11, wherein the processing module is a Backend IC, a Digital Signal Processor (DSP) or a baseband CPU.
